(19) United States
(12) Patent Application Publication
(10) Pub. No.: US 2022/0191739 A1
(43) Pub. Date: Jun. 16, 2022

(54) COMMUNICATION CONTROL APPARATUS, COMMUNICATION CONTROL METHOD, AND NON-TRANSITORY COMPUTER-READABLE MEDIUM

(71) Applicant: NEC Corporation, Minato-ku, Tokyo (JP)

(72) Inventors: Nobuhiko ITOH, Tokyo (JP); Kosei KOBAYASHI, Tokyo (JP); Takanori IWAI, Tokyo (JP)

(73) Assignee: NEC Corporation, Minato-ku, Tokyo (JP)

(21) Appl. No.: 17/432,244

(22) PCT Filed: Jan. 16, 2020
(86) PCT No.: PCT/JP2020/001308

§ 371 Date: Aug. 19, 2021

(30) Foreign Application Priority Data
Feb. 26, 2019 (JP) 2019-032759

(51) Int. Cl. H04W 28/08; H04W 28/02; H04W 28/24; H04W 24/08

(52) U.S. Cl. CPC H04W 28/0975; H04W 24/08; H04W 28/24; H04W 28/0268

(57) ABSTRACT

Provided is a communication control apparatus which can perform efficient delay control for maintaining quality of an end-to-end flow. A communication control apparatus (10) according to the present disclosure includes an acquiring unit (11) acquiring measured delay times that are end-to-end delay times of a plurality of data pieces included in a flow sent through a plurality of sections, a calculating unit (12) calculating a delay adjustment amount required for satisfying target quality by the flow by using the measured delay times and a target end-to-end delay time that the flow should satisfy, and an updating unit (13) apportioning the delay adjustment amount to each of the sections and updating a target delay time specified in each of the sections by using the apportioned delay adjustment amount.

### TECHNICAL FIELD

The present disclosure relates to a communication control apparatus, a communication control method, and a program.

### BACKGROUND ART

Presently, providing an ultra low latency service over a mobile network is being studied. The ultra low latency service may be, for example, an automatic operation service that transmits vehicle-mounted sensor information, traffic camera information, map information and so on over a mobile network.

A mobile carrier (mobile communication carrier) is required to guarantee Service Level Agreement (SLA) for providing the ultra low latency service to users. In SLA, for example, a delay time or the like to be guaranteed in the ultra low latency service may be specified.

Patent Literature 1 discloses that a packet that reaches a destination device via a plurality of nodes includes information regarding a cumulative arrival delay passed until the packet reaches transient nodes. Furthermore, a node device having received a packet selects a transmission profile such that the cumulative arrival delay exhibited by the packet becomes closer to a target cumulative delay preset for the next node. A parameter is set for each of a plurality of transmission profiles such that packets that reach a certain node have different expected arrival delay times when the packets reach the next node.

### CITATION LIST

### Patent Literature

Patent Literature 1: Japanese Unexamined Patent Application Publication No. 2008-167141

### SUMMARY OF INVENTION

### Technical Problem

In a case where a target delay time is specified for an end-to-end flow including a plurality of packets, the quality of the flow depends on the actual end-to-end delay time. In other words, when the end-to-end delay time is less than a target delay time, a control that shortens the delay at a transient node is not required to be performed even though the cumulative arrival delay at the transient node is greater than the target cumulative delay. The case where the delay time is less than a target delay time is a case where the delay time is shorter than the target delay time. Also, when the end-to-end delay time is greater than the target delay time, a control that shortens the delay may be required to be performed in order to reduce the processing load at a subsequent node even though the cumulative arrival delay at a transient node is less than the target delay time. When the delay control disclosed in Patent Literature 1 is executed, there is a problem that the control may be excessive or may be insufficient for maintaining the quality of the end-to-end flow.

It is an object of the present disclosure to provide a communication control apparatus, a communication control method and a program that can perform efficient delay control over an end-to-end flow.

### Solution to Problem

A communication control apparatus according to a first aspect of the present disclosure includes an acquiring unit acquiring measured delay times that are end-to-end delay times of a plurality of data pieces included in a flow sent through a plurality of sections, a calculating unit calculating a delay adjustment amount required for satisfying target quality by the flow by using the measured delay times and a target end-to-end delay time that the flow should satisfy, and an updating unit apportioning the delay adjustment amount to each of the sections and updating a target delay time specified in each of the sections by using the apportioned delay adjustment amount.

A communication control method according to a second aspect of the present disclosure to be executed in a communication control apparatus includes acquiring measured delay times that are end-to-end delay times of a plurality of data pieces included in a flow sent through a plurality of sections, calculating a delay adjustment amount required for satisfying target quality by the flow by using the measured delay times and a target end-to-end delay time that the flow should satisfy, and apportioning the delay adjustment amount to each of the sections and updating a target delay time specified in each of the sections by using the apportioned delay adjustment amount.

A program according to a third aspect of the present disclosure causes a computer to acquire measured delay times that are end-to-end delay times of a plurality of data pieces included in a flow sent through a plurality of sections, calculate a delay adjustment amount required for satisfying target quality by the flow by using the measured delay times and a target end-to-end delay time that the flow should satisfy, and apportion the delay adjustment amount to each of the sections and update a target delay time specified in each of the sections by using the apportioned delay adjustment amount.

### Advantageous Effects of Invention

According to the present disclosure, a communication control apparatus, a communication control method and a program that can perform efficient delay control for maintaining quality of an end-to-end flow can be provided.

### BRIEF DESCRIPTION OF DRAWINGS

FIG. 1 is a configuration diagram of a communication control apparatus according to a first example embodiment.

FIG. 2 is a configuration diagram of a communication system according to a second example embodiment.

FIG. 3 is a configuration diagram of a communication control apparatus according to the second example embodiment.

FIG. 4 is a diagram showing information managed by a measured delay managing unit according to the second example embodiment.

FIG. 5 is a diagram showing information managed by a target delay managing unit according to the second example embodiment.

FIG. 6 is a diagram showing a flow of processing of updating a target delay according to the second example embodiment.

FIG. 7 is a configuration diagram of the communication control apparatus according to each of the example embodiments.

### DESCRIPTION OF EMBODIMENTS

### First Example Embodiment

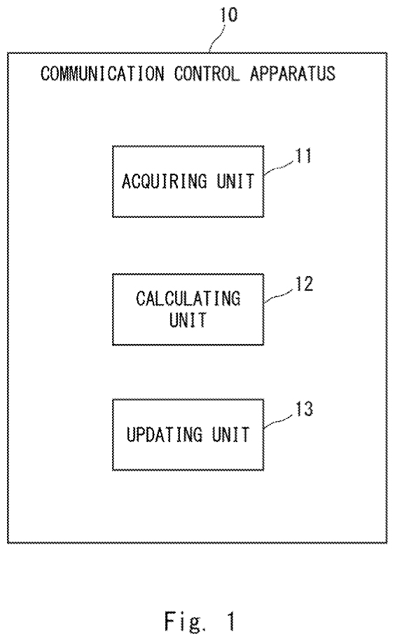

Example embodiments of the present disclosure are described below with reference to drawings. A configuration example of a communication control apparatus 10 according to a first example embodiment is described with reference to FIG. 1. The communication control apparatus 10 may be a computer apparatus that operates because a processor executes a program stored in a memory. The communication control apparatus 10 includes an acquiring unit 11, a calculating unit 12, and an updating unit 13. The constituent elements of the communication control apparatus 10 such as the acquiring unit 11, the calculating unit 12 and the updating unit 13 may be software or a module by which processing is performed because a processor executes a program stored in a memory. Also, the constituent elements of the communication control apparatus 10 such as the acquiring unit 11, the calculating unit 12, and the updating unit 13 may be hardware such as a circuit or a chip.

The acquiring unit 11 acquires measured delay times that are end-to-end delay times of a plurality of data pieces included in a flow sent via a plurality of sections. The flow includes one or a plurality of data pieces to be transmitted in an application service provided to a communication terminal. A data piece included in the flow may be called a “data packet”. Also, a data piece included in the flow may be called a “chunk” that is configured by using one or more data packets. The flow includes one or a plurality of data pieces to be sent or received, for example, between communication terminals, between a communication terminal and a server apparatus, or between a communication terminal and a relay device.

The data (for example, application data) to be transmitted in an application service may be, for example, image data, a moving image data or the like. Also, the application data may include a request message that requests to send image data or the like, a response message that responds to a request message or the like.

The measured delay time may be a period of time from a time at which a sender of an application layer sends data to a time at which reception of the data by a receiver of the application layer completes. Alternatively, the measured delay time may be a period of time from a time at which a sender of a wireless layer sends data to a time at which reception of the data by a receiver of the wireless layer completes.

The acquiring unit 11 may acquire, over a network, measured delay times that are measured in a communication terminal, server apparatus, relay device or the like which receives data. Alternatively, in a case where the communication control apparatus 10 is incorporated in a communication terminal, a server apparatus, a relay device or the like, a measured delay time of received data may be measured. Measuring a measured delay time may be, for example, calculating a difference between a time at which sending has started, which is included in data, and a time at which the apparatus having received the data has received the data.

By using the measured delay times and a target delay time to be satisfied by a flow including data pieces the measured delay times of which have been measured, the calculating unit 12 calculates a delay adjustment amount required by the flow for satisfying target quality. The target delay time is requested by, for example, an application. The target delay may be interchanged with “allowable delay”.

The target delay time may be called a “deadline” or a “sending deadline”. The target delay time refers to a deadline by which sending of a plurality of data packets included in one flow should be completed. The target delay time can also be called a “deadline for sending”. Alternatively, the target delay time can also be called “maximum sending delay” that is allowable by an application. The target delay time can be defined in various manners. For example, the target delay time may indicate a completion deadline of sending by a sender of an application layer. Alternatively, the target delay time may indicate a completion deadline of sending by a sender of a wireless layer. Alternatively, the target delay time may indicate a completion deadline of receiving by a receiver of an application layer. Alternatively, the target delay time may indicate a completion deadline of receiving by a receiver of a wireless layer. Alternatively, the target delay time may indicate a deadline of completion of reception of the last packet relating to one flow by a receiver of an application layer after start of sending of the first data packet relating to the one flow by a sender of the application layer. Alternatively, the target delay time may indicate a deadline of completion of reception of the last data packet relating to one flow by a receiver of a wireless layer after start of sending of the first data packet relating to the one flow by a sender of the wireless layer.

The target quality of a flow may be that, for example, the proportion of data pieces having measured delay times less than the target delay time is 95% or higher of a plurality of data pieces included in the flow. The value “95%” may be any other arbitrary value. The expression “data pieces having measured delay times less than the target delay time” may be interchanged with an expression “data pieces having measured delay times that satisfy the target delay time”. In other words, a data piece having a measured delay time less than the target delay time is a data piece having a measured delay time shorter than the target delay time.

Alternatively, the target quality of a flow may be specified by using a throughput, a data loss rate or the like of a plurality of data pieces included in the flow.

The delay adjustment amount may indicate, for example, a difference between a current target delay time and a changed target delay time. As the target delay time of a flow is reduced, the communication resource for transmitting each data piece included in the flow is increased. That is to say, as the target delay time of a flow is reduced, the priority level of the flow increases. In other words, as the target delay time of a flow is reduced, communication resource is allocated thereto by priority in order to send a plurality of data pieces included in the flow.

The communication resource may be, for example, a communication band. Also, the term “communication resource” may be interchanged with a term “radio resource”. The radio resource may be a time resource, a frequency resource, a transmission power resource or a combination thereof. In order to increase radio resource by using a time resource, for example, the transmission cycle or transmission interval may be shortened, or the transmission frequency may be increased. In order to increase radio resource by using a frequency resource, for example, a frequency band, the number of sub carriers or the number of channels to be allocated may be increased. In order to increase radio resource by using a transmission power resource, for example, the transmission power may be increased. Alternatively, a control over the radio resource may be a change of a modulation method or an error correction method. In order to increase the priority level of a communication, for example, the modulation method or the error correction level may be changed to one having a higher error tolerance.

For example, if the calculating unit 12 determines that the target quality that a flow should satisfy is not satisfied as a result of an analysis performed on measured delay times of a plurality of data pieces included in the flow and the target delay time that the flow should satisfy, the calculating unit 12 may calculate a delay adjustment amount such that the target delay time can be shorter. Also, if the calculating unit 12 determines that the target quality that a flow should satisfy is satisfied as a result of an analysis performed on measured delay times of a plurality of data pieces included in the flow and the target delay time that the flow should satisfy, the calculating unit 12 may calculate a delay adjustment amount such that the target delay time can be longer.

The updating unit 13 apportions the calculated delay adjustment amount to each of sections that the flow passes through and updates the target delay time specified in each of the sections by using the apportioned delay adjustment amount. The target delay time specified in each of the sections is specified such that a total time of target delay times specified in the sections is equal to or less than the target end-to-end delay time.

The delay adjustment amount calculated in the calculating unit 12 may be evenly apportioned to each section or may be apportioned such that the delay adjustment amount apportioned to partial sections is different from the delay adjustment amount apportioned to the other sections. A node that sends data in each of the sections allocates communication resource to data pieces included in a flow in accordance with the updated target delay time. The target delay time which is calculated in the calculating unit 12 and is updated in each section is sent to a node that sends data in each section. Alternatively, the updated target delay time is sent to a device or node that performs a control that allocates communication resource.

As described above, the communication control apparatus 10 according to the first example embodiment calculates a delay adjustment amount in accordance with, for example, measured end-to-end delay times of a plurality of data pieces included in a flow and a target delay time that the flow should satisfy. Furthermore, the communication control apparatus 10 apportions the delay adjustment amount to each section. As a result, the communication control apparatus 10 can execute a delay control so as to satisfy the target end-to-end quality. In other words, the communication control apparatus 10 can maintain or improve quality of the end-to-end flow by efficiently performing the delay control.

### Second Example Embodiment

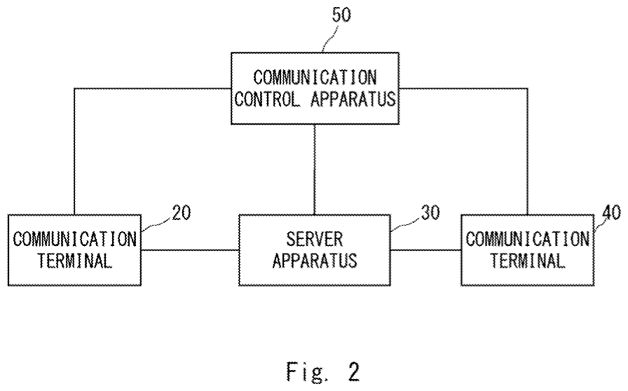

Next, a configuration example of a communication system according to a second example embodiment is described with reference to FIG. 2. The communication system in FIG. 2 includes a communication terminal 20, a server apparatus 30, a communication terminal 40, and a communication control apparatus 50. The communication terminal 20, the server apparatus 30, the communication terminal 40 and the communication control apparatus 50 may be computer apparatuses that operate because a processor executes a program stored in a memory. The communication control apparatus 50 corresponds to the communication control apparatus 10 in FIG. 1.

In the communication system in FIG. 2, it is assumed that a flow sent from the communication terminal 20 reaches the communication terminal 40 through the server apparatus 30. It is assumed that a communication path between the communication terminal 20 and the server apparatus 30 is an uplink section, and a communication path between the server apparatus 30 and the communication terminal 40 is a downlink section.

Also, one or more relay devices (not shown) may be disposed in the paths between the apparatuses.

The communication terminal 20 and the communication terminal 40 may be computer apparatuses each having a communication function, such as a cellular phone terminal or a smartphone terminal. Also, the communication terminal 20 and the communication terminal 40 may be an Internet of Things (IoT) terminal, a Machine Type Communication (MTC) terminal or the like.

The server apparatus 30 may be, for example, an application server. The server apparatus 30 provides, for example, an application service, a communication service or the like to the communication terminal 20 and the communication terminal 40 over a network. Also, the server apparatus 30 may perform an allocation control over communication resource based on target delay times of the uplink section and downlink section sent from the communication control apparatus 50. For example, the server apparatus 30 may allocate communication resource for sending data by the communication terminal 20 to the communication terminal 20 in the uplink section. The server apparatus 30 may adjust or control communication resource for sending data to the communication terminal 40 in the downlink section. In other words, the server apparatus 30 decides the amount of communication resource for sending data to the communication terminal 40 in the downlink section. Alternatively, the server apparatus 30 may notify the communication resource to be allocated for sending by the communication terminal 20 to a relay device or the like disposed in the uplink section, and the relay device or the like may execute an allocation control over the communication resource. Alternatively, the server apparatus 30 may notify communication resource to be allocated for sending data to the communication terminal 40 to a relay device or the like disposed in the downlink section, and the relay device or the like may execute an allocation control over the communication resource. Alternatively, the relay device or the like may receive information regarding a target delay time in each of the sections and perform a control that allocates communication resource in accordance with the target delay time.

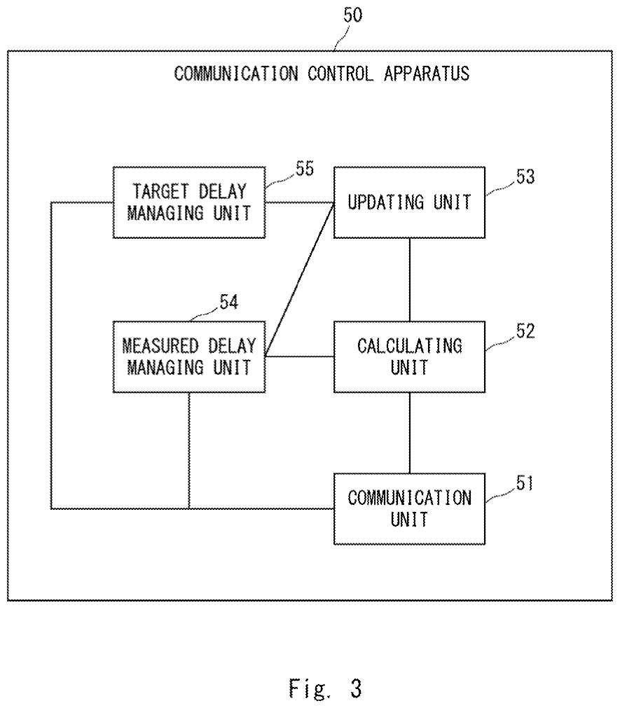

Next, a configuration example of the communication control apparatus 50 according to the second example embodiment is described with reference to FIG. 3. The communication control apparatus 50 has a communication unit 51, a calculating unit 52, an updating unit 53, a measured delay managing unit 54, and a target delay managing unit 55. The communication unit 51 corresponds to the acquiring unit 11 in the communication control apparatus 10 in FIG. 1. The calculating unit 52 corresponds to the calculating unit 12 in the communication control apparatus 10. The updating unit 53 corresponds to the updating unit 13 in FIG. 1.

The communication unit 51 receives a measured end-to-end delay time of a data piece transmitted from the communication terminal 20 or the communication terminal 40 to the communication terminal 20 and the communication terminal 40. For example, the communication terminal 40 may measure a measured delay time by calculating a difference between information regarding a sending start time set at a header or the like of a data piece sent from the communication terminal 20 and a time at which the data piece is received. The communication terminal 20 or the communication terminal 40 sends the information regarding the measured delay time of the data to the communication control apparatus 50 over the network. The communication control apparatus 50 may receive the data piece sent through the server apparatus 30 or may receive the data sent through a path excluding the server apparatus 30.

Alternatively, the communication unit 51 may receive a measured delay time from a measurement device or the like that measures a measured end-to-end delay time of a data piece transmitted between the communication terminal 20 and the communication terminal 40. The measurement device may be, for example, a relay device that relays data between the communication terminal 20 and the communication terminal 40 or a management device or the like that manages subscriber information or the like for the communication terminal 20 and the communication terminal 40.

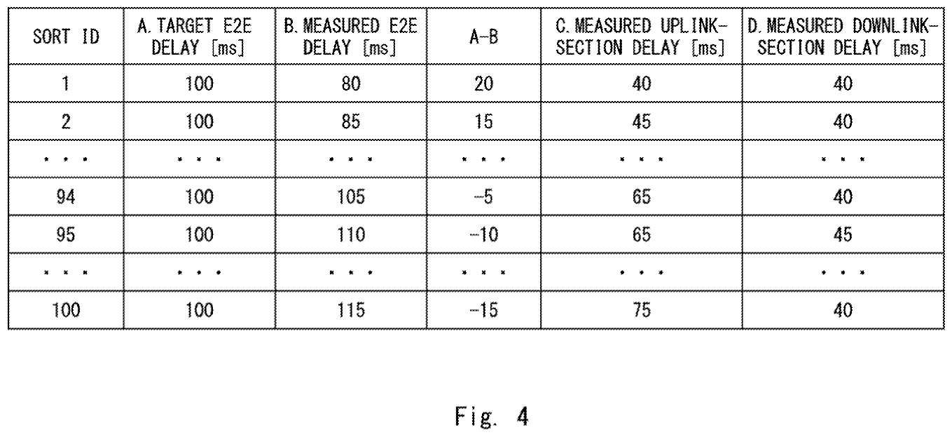

The calculating unit 52 calculates a delay adjustment amount by using information managed by the measured delay managing unit 54. Furthermore, the updating unit 53 updates a target delay time by using the information managed by the measured delay managing unit 54 and information managed by the target delay managing unit 55. The information managed by the measured delay managing unit 54 is now described with reference to FIG. 4.

FIG. 4 shows, for example, 100 data pieces included in a flow sent from the communication terminal 20 to the communication terminal 40. In other words, information in FIG. 4 may be managed for each flow. A “Sort ID” indicates serial numbers of 100 data pieces arranged in order from a data piece having the shortest measured delay time. A “Target E2E Delay Time” indicates a target delay time set for the flow. Therefore, an identical value is set for all data pieces within one flow.

A “Measured E2E Delay” indicates a measured delay time of each data piece. “A-B” indicates a value acquired by subtracting the measured E2E delay from the target E2E delay. In other words, when “A-B” indicates a positive value, it means that the data piece has a measured delay value lower than the target delay value. In other words, when “A-B” indicates a positive value, it means that the data piece satisfies the target delay. When “A-B” indicates a negative value, it means that the corresponding data piece has a measured delay value higher than the target delay value. In other words, when “A-B” indicates a negative value, it means that the corresponding data piece does not satisfy the target delay.

A “Measured Uplink-Section Delay” indicates a measured delay time between the communication terminal 20 and the server apparatus 30 of each of the data pieces. A “Measured Downlink-Section Delay” indicates a measured delay time between the server apparatus 30 and the communication terminal 40 of each of the data pieces.

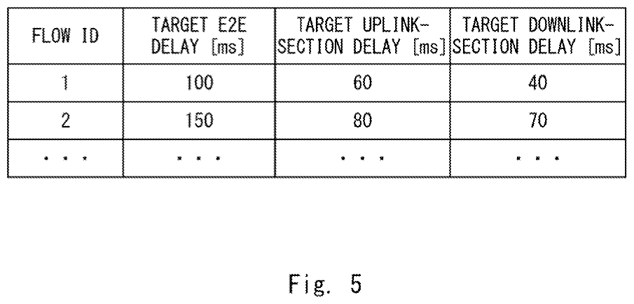

Next, the information managed by the target delay managing unit 55 is described with reference to FIG. 5. FIG. 5 manages, for each flow, the Target E2E Delay, the Target Uplink-Section Delay and the Target Downlink-Section Delay. The “Target Uplink-Section Delay” indicates a target delay time between a sending communication terminal and the server apparatus 30. The “Target Downlink-Section Delay” indicates a target delay time between the server apparatus 30 and a receiving communication terminal. For example, FIG. 5 shows that the target end-to-end delay time of a flow having “1” as its flow ID is 100 ms, the target uplink-section delay is 60 ms, and the target downlink-section delay is 40 ms. Also, it is assumed here that FIG. 4 manages data pieces included in the flow having “1” as its flow ID.

Referring back to FIG. 3, the processing of calculating a delay adjustment amount in the calculating unit 52 is described. Here, the target quality of the flow ID_1 is set such that the proportion of the data pieces that satisfy the target delay time is 95% or higher of the plurality of data pieces included in the flow. Referring to FIG. 4 that manages data in the flow ID_1, in order to satisfy the target quality, when the target delay time is satisfied at the sort ID_95, it means that the flow ID_1 satisfies the target quality.

Here, focusing on the sort ID_95, the value of A-B is indicated as −10. Accordingly, the calculating unit 52 calculates a value of A-B at the sort ID_95 and decides the value as a delay adjustment amount. In the example in FIG. 4, the calculating unit 52 decides the delay adjustment amount of the flow ID_1 as −10. A delay adjustment amount of −10 means that the target end-to-end delay time is to be changed from current 100 ms to 90 ms.

Next, processing of updating a target delay time in the updating unit 53 is described. The updating unit 53 counts the number of data pieces having measured uplink-section delays exceeding the target uplink-section delay of the flow ID_1 managed in the target delay managing unit 55 among measured uplink-section delays of 100 data pieces in the measured delay managing unit 54. The number of data pieces having measured uplink-section delays exceeding the target uplink-section delay is indicated as the number of violations Vu of the target delay in the uplink section. Referring to FIG. 5, the target uplink-section delay of the flow ID_1 is set as 60 ms. The updating unit 53 counts the number of data pieces having measured uplink-section delays exceeding 60 ms among the sort ID_1 to the sort ID_100. For example, it is assumed that the number of data pieces having measured uplink-section delays exceeding 60 ms is 8.

Furthermore, the updating unit 53 counts the number of data pieces having measured downlink-section delays exceeding a target downlink-section delay of the flow ID_1 managed in the target delay managing unit 55 among the measured downlink-section delays of 100 data pieces in the measured delay managing unit 54. The number of data pieces having measured downlink-section delays exceeding the target downlink-section delay is indicated as the number of violations Vd of the target delay in the downlink section. For example, it is assumed that the number of data pieces having measured downlink-section delays exceeding 40 ms is 2.

Here, the updating unit 53 calculates delay adjustment allowances in the uplink section and the downlink section. The delay adjustment allowance in the uplink section indicates a proportion of a delay adjustment amount to be apportioned to the target uplink-section delay of the delay adjustment amount. The delay adjustment allowance in the downlink section indicates a proportion of a delay adjustment amount to be apportioned to the target downlink-section delay of the delay adjustment amount.

Specifically, the updating unit 53 calculates a delay adjustment allowance in the uplink section by using an expression of 1:a=Vd/(Vu+Vd) where a is the delay adjustment allowance in the uplink section. Furthermore, the updating unit 53 calculates a delay adjustment allowance in the downlink section as 1-a. When Vu=8 and Vd=2, the delay adjustment allowance a in the uplink section is equal to 0.8, and the delay adjustment allowance in the downlink section is equal to 0.2.

By using the delay adjustment allowances in the uplink section and the downlink section, the updating unit 53 updates the target delay times of the uplink section and the downlink section. Specifically, the updated target uplink-section delay=delay adjustment amount×delay adjustment allowance of the uplink section+current target uplink-section delay=−10×0.8+60=52 ms. Furthermore, the updated target downlink-section delay=delay adjustment amount×delay adjustment allowance of the downlink section+current target downlink-section delay=−10×0.2+40=38 ms.

The updating unit 53 sends the information regarding the updated target uplink-section delay and the updated target downlink-section delay to the server apparatus 30 via the communication unit 51. The server apparatus 30 performs a communication resource allocation control based on the updated target uplink-section delay and the updated target downlink-section delay. The updated target uplink-section delay and the updated target downlink-section delay when the delay adjustment amount is −10 are changed to values smaller than the values before the updates. In this case, the server apparatus 30 increases the communication resource to be allocated to the communication terminal 20 that sends data in the uplink section more than a case where the target uplink-section delay before the update is used. Also, the server apparatus 30 increases the communication resource for sending data to the communication terminal 40 in the downlink section more than a case where the target downlink-section delay before the update is used.

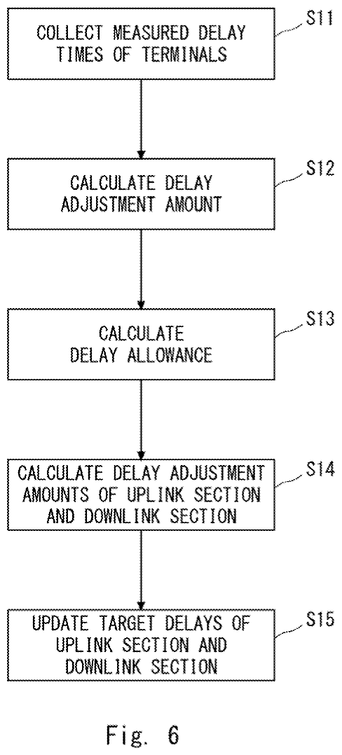

Next, a flow of the processing of updating a target delay according to the second example embodiment is described with reference to FIG. 6. First, the communication unit 51 collects measured delay times from a plurality of communication terminals (S11). The collected measured delay times are managed as shown in FIG. 4 for each flow in the measured delay managing unit 54.

Next, the calculating unit 52 calculates a delay adjustment amount so as to satisfy the target quality of the flow (S12). The calculating unit 52 extracts a flow that does not satisfy the target quality and calculates a delay adjustment amount by using a data piece having a predetermined sort ID of the extracted flow.

Next, the updating unit 53 calculates a delay allowance by using the measured delay times of the uplink section and the downlink section of each data piece included in the flow extracted in step S12 (S13). Next, the updating unit 53 calculates delay adjustment amounts for the uplink section and the downlink section by using the delay adjustment amount calculated in the step S12 and the delay allowance (S14).

The updating unit 53 in step S12 may set priority levels for a plurality of flows extracted as flows that do not satisfy the target quality and calculate a delay allowance only for a flow for which a priority level higher than a predetermined priority level is set. For example, the updating unit 53 may set a higher priority level for a flow having a delay adjustment amount closer to 0 and may set a lower priority level for a flow having a delay adjustment amount farther from 0. The updating unit 53 can set a less adjustment amount or control amount for a flow having a delay adjustment amount closer to 0 than a flow having a delay amount farther from 0. When the adjustment amount for the target delay time is less, the server apparatus 30 can also reduce the amount of change of communication resource to be allocated. As a result, the processing load in the server apparatus 30 can be reduced. Also, because the load of control relating to allocation of communication resource of one flow can be reduced, a control that changes communication resource to be allocated can be executed on a plurality of flows. In other words, by calculating a delay allowance by priority from a flow having a delay adjustment amount closer to 0, an improvement can be achieved to bring the quality of more flows closer to the target quality.

Next, by using the delay adjustment amounts in the uplink section and the downlink section calculated in step S14, the updating unit 53 updates the target delays of the uplink section and the downlink section (S15).

As described above, if the measured end-to-end delay time does not satisfy the target end-to-end delay time, the communication control apparatus 50 according to the second example embodiment can update the target delay times in the uplink section and the downlink section. Also, in accordance with the number of violations of the target delay times in the uplink section and the downlink section, the communication control apparatus 50 can update the target delay times in the uplink section and the downlink section. Thus, the communication control apparatus 50 can update the target delay time in a section that needs to be improved in accordance with the necessity of the improvement if the measured end-to-end delay time does not satisfy the target end-to-end delay. In other words, the communication control apparatus 10 can maintain or improve quality of the end-to-end flow by efficiently performing the delay control.

### Variation Examples of Second Example Embodiment

The processing according to the second example embodiment has been described in which the communication control apparatus 50 updates the target delay times of the uplink section and the downlink section for a flow that does not satisfy a target end-to-end delay time. The communication control apparatus 50 may further update the target delay times of the uplink section and the downlink section also for a flow that satisfies a target end-to-end delay. The updating the target delay time for a flow that satisfies a target end-to-end delay time is to increase the target delay time from the current target delay time. In other words, the allocation of communication resource to the flow is reduced by updating the target delay time for a flow that satisfies a target end-to-end delay time.

The communication control apparatus 50 may set the delay adjustment amount for a flow that satisfies a target end-to-end delay to a similar extent to the delay adjustment amount for a flow that does not satisfy the target end-to-end delay.

By updating the target delays for a flow that does not satisfy the target end-to-end delay and for a flow that satisfies the target end-to-end delay, finite communication resource can be efficiently used.

Also, among flows that satisfy a target end-to-end delay, a higher priority level may be set for a flow having a delay adjustment amount closer to 0, and a lower priority level may be set for a flow having a delay adjustment amount farther from 0. Alternatively, among flows that satisfy a target end-to-end delay, a higher priority level may be set for a flow having a delay adjustment amount farther from 0, and a lower priority level may be set for a flow having a delay adjustment amount closer to 0.

It should be noted that the present disclosure is not limited to the aforementioned example embodiments but can be changed as appropriate without departing from the spirit and scope of the present disclosure.

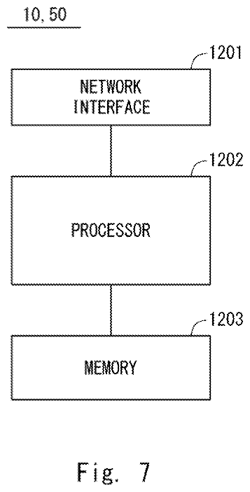

FIG. 7 is a block diagram showing a configuration example of the communication control apparatuses 10 and 50 (hereinafter, “communication control apparatus 10 or the like”). Referring to FIG. 7, the communication control apparatus 10 or the like includes a network interface 1201, a processor 1202, and a memory 1203. The network interface 1201 is used for communicating with another network node device included in the communication system. The network interface 1201 may include a network interface card (NIC) based on, for example, IEEE 802.3 series. Alternatively, the network interface 1201 may be used for performing wireless communication. For example, the network interface 1201 may be used for performing wireless LAN communication or mobile communication provided in 3rd Generation Partnership Project (3GPP).

The processor 1202 reads and executes software (computer program) from the memory 1203 to implement processing of the communication control apparatus 10 or the like described by using the flowchart or sequence according to the aforementioned example embodiments. The processor 1202 may be, for example, a microprocessor, a micro processing unit (MPU), or a central processing unit (CPU). The processor 1202 may include a plurality of processors.

The memory 1203 includes a combination of a volatile memory and a non-volatile memory. The memory 1203 may include a storage arranged separately from the processor 1202. In this case, the processor 1202 may access the memory 1203 via an I/O interface, not shown.

In the example in FIG. 7, the memory 1203 is used for storing a software module group. The processor 1202 reads and executes the software module group from the memory 1203 and can thus implement processing of the communication control apparatus 10 or the like described according to the aforementioned example embodiments.

As described with reference to FIG. 7, each of the processors included in the communication control apparatus 10 or the like executes one or a plurality of programs including an instruction group for causing a computer to perform an algorithm described with reference to the drawings.

In the aforementioned example, the program or programs can be stored by using various types of non-transitory computer-readable medium and can be supplied to a computer. The non-transitory computer-readable medium includes various types of tangible storage medium. Examples of the non-transitory computer-readable medium include a magnetic recording medium, a magneto-optical recording medium (such as a magneto-optical disk), a CD read only memory (CD-ROM), a CD-R, a CD-R/W, and a semiconductor memory. The magnetic recording medium may be, for example, a flexible disk, a magnetic tape, or a hard disk drive. The semiconductor memory may be, for example, a mask ROM, a programmable ROM (PROM), an erasable PROM (EPROM), a flash ROM, or a random access memory (RAM). Also, the program or programs may be supplied to a computer through various types of transitory computer-readable medium. Examples of the transitory computer-readable medium include an electric signal, an optical signal and electromagnetic waves. The transitory computer-readable medium can supply the program or programs to a computer via a wired communication path such as an electric wire and an optical fiber or a wireless communication path.

Having described above the present invention of the subject application with reference to the example embodiments, the present invention of the subject application is not limited by the description above. Various changes that can be understood by those skilled in the art without departing from the scope of the invention can be made to the configuration and details of the present invention of the subject application.

This application claims priority based on Japanese Patent Application No. 2019-032759 filed on Feb. 26, 2019, the entirety of which is incorporated herein.

### REFERENCE SIGNS LIST

10 COMMUNICATION CONTROL APPARATUS
11 ACQUIRING UNIT
12 CALCULATING UNIT
13 UPDATING UNIT
20 COMMUNICATION TERMINAL
30 SERVER APPARATUS
40 COMMUNICATION TERMINAL
50 COMMUNICATION CONTROL APPARATUS
51 COMMUNICATION UNIT
52 CALCULATING UNIT
53 UPDATING UNIT
54 MEASURED DELAY MANAGING UNIT
55 TARGET DELAY MANAGING UNIT

What is claimed is:

1. A communication control apparatus comprising:
at least one memory storing instructions, and
at least one processor configured to execute the instructions to:
acquire measured delay times that are end-to-end delay times of a plurality of data pieces included in a flow sent through a plurality of sections;
calculate a delay adjustment amount required for satisfying target quality by the flow by using the measured delay times and a target end-to-end delay time that the flow should satisfy; and
apportion the delay adjustment amount to each of the sections and updating a target delay time specified in each of the sections by using the apportioned delay adjustment amount.

2. The communication control apparatus according to claim 1, wherein
the at least one processor is further configured to execute the instructions to the acquire a measured delay time in each of the sections, and
apportion the delay adjustment amount to each of the sections based on the number of violations indicating the number of times at which the measured delay time does not satisfy a target delay time in each of the sections.

3. The communication control apparatus according to claim 2, wherein the at least one processor is further configured to execute the instructions to apportion more delay adjustment amount to a section having a lower number of violations than a section having a higher number of violations.

4. The communication control apparatus according to claim 3, wherein the at least one processor is further configured to execute the instructions to calculate the delay adjustment amount such that a proportion of data pieces that satisfy the target delay time among the plurality of data pieces included in the flow is higher than or equal to a predetermined value.

5. The communication control apparatus according to claim 1, wherein the at least one processor is further configured to execute the instructions to calculate a difference between the measured delay time and the target delay time that the flow should satisfy for each of the data pieces and calculate the delay adjustment amount by using the difference calculated in a data piece at a predetermined ordinal level when the data pieces are arranged in increasing order or decreasing order of the calculated difference.

6. The communication control apparatus according to claim 1, wherein the at least one processor is further configured to execute the instructions to calculate the delay adjustment amount such that the target delay time that the flow satisfying the target quality should satisfy is long and calculate the delay adjustment amount such that the target delay time that the flow not satisfying the target quality should satisfy is short.

7. A communication control method to be executed in a communication control apparatus, the method comprising:
acquiring measured delay times that are end-to-end delay times of a plurality of data pieces included in a flow sent through a plurality of sections;
calculating a delay adjustment amount required for satisfying target quality by the flow by using the measured delay times and a target end-to-end delay time that the flow should satisfy; and
apportioning the delay adjustment amount to each of the sections and updating a target delay time specified in each of the sections by using the apportioned delay adjustment amount.

8. A non-transitory computer-readable medium storing a program causing a computer to:
acquire measured delay times that are end-to-end delay times of a plurality of data pieces included in a flow sent through a plurality of sections;
calculate a delay adjustment amount required for satisfying target quality by the flow by using the measured delay times and a target end-to-end delay time that the flow should satisfy; and
apportion the delay adjustment amount to each of the sections and update a target delay time specified in each of the sections by using the apportioned delay adjustment amount.
